(19) United States
(12) Patent Application Publication
(10) Pub. No.: US 2018/0130193 A1
(43) Pub. Date: May 10, 2018

(54) SIMULTANEOUS ESTIMATION OF LOCATION ELEVATIONS AND WATER LEVELS

(71) Applicant: Regents of the University of Minnesota, Minneapolis, MN (US)

(72) Inventors: Varun Mithal, Minneapolis, MN (US); Ankush Khandelwal, Minneapolis, MN (US); Vipin Kumar, Minneapolis, MN (US)

(21) Appl. No.: 15/807,135

(22) Filed: Nov. 8, 2017

Related U.S. Application Data
(60) Provisional application No. 62/419,551, filed on Nov. 9, 2016.

(51) Int. Cl. G06T 7/00; G06K 9/62; G06K 9/03; G06T 7/12; G06T 7/162

(52) U.S. Cl. CPC G06T 7/0002; G06K 9/6202; G06K 9/03; G06T 7/12; G06T 2207/30204; G06T 7/97; G06K 9/6267; G06T 2207/10032; G06T 2207/30181; G06T 7/162

(57) ABSTRACT

A method improves automated water body extent determinations using satellite sensor values and includes a processor receiving a time-sequence of land cover labels for a plurality of geographic areas represented by pixels in the satellite sensor values. The processor alternates between ordering the geographic areas based on a water level estimates at each time point in the time sequence such that the order of the geographic areas reflects an estimate of the relative elevations of the geographic areas and updating the water level estimates based on the land cover labels for the geographic areas. A final ordering of the geographic areas and a final water level estimate are used to correct the time-sequence of land cover labels.

### CROSS-REFERENCE OF RELATED APPLICATION

The present application is based on and claims the benefit of U.S. provisional patent application Ser. No. 62/419,551, filed Nov. 9, 2016, the content of which is hereby incorporated by reference in its entirety.

This invention was made with government support under CCF-1029711 awarded by the National Science Foundation and NNX12AP37G awarded by National Aeronautics and Space Administration. The government has certain rights in the invention.

### BACKGROUND

Freshwater from lakes plays an essential role in supporting a variety of human needs, such as drinking, agriculture, and industrial development. Lakes are dynamic in nature, they shrink, expand, or change their appearance, owing to a number of natural and human-induced factors. As an example, the Aral Sea has been steadily shrinking since the 1960s due to the undertaking of irrigation projects (compare FIG. 1(a) to FIG. 1(b)), which has resulted in the collapse of fisheries and other communities that were once supported by the lake, and has further altered the local climatic conditions. Global mapping and monitoring of the extent and growth of surface water bodies such as lakes is thus important for assessing the impact of human actions on water resources, as well as for conducting research that studies the interplay between water dynamics and global climate change.

### SUMMARY

A method improves automated water body extent determinations using satellite sensor values and includes a processor receiving a time-sequence of land cover labels for a plurality of geographic areas represented by pixels in the satellite sensor values. The processor alternates between ordering the geographic areas based on a water level estimates at each time point in the time sequence such that the order of the geographic areas reflects an estimate of the relative elevations of the geographic areas and updating the water level estimates based on the land cover labels for the geographic areas. A final ordering of the geographic areas and a final water level estimate are used to correct the time-sequence of land cover labels.

In accordance with a further embodiment, a system includes a memory and a processor. The memory stores a time sequence of land cover labels for a plurality of geographic locations wherein the time sequences of land cover labels are generated from satellite sensor data. The processor iteratively establishes a relative elevation for each geographic location in the plurality of geographic locations and a water level at each time point in the time sequence to form final relative elevations for the plurality of geographic locations and final water levels at each time point. The processor uses the final relative elevations for the plurality of geographic locations and the final water levels to modify the time sequence of land cover labels for the plurality of geographic locations to thereby correct at least one land cover label.

In accordance with a still further embodiment, a computer-implemented method includes setting a time-sequence of water levels relative to a set of geographic locations based on land cover labels for the geographic locations. The geographic locations are then organized based on the time-sequence of water levels to form an ordered list of geographic locations. The ordered list of geographic locations and the time-sequence of water levels are then used to correct an error in at least one of the land cover labels.

### BRIEF DESCRIPTION OF THE DRAWINGS

FIGS. 1(a) and 1(b) show changes in the satellite images of the Aral sea over time.

FIG. 2(a) shows a false color composite of Lake Abbe.

FIG. 2(b) shows an image based on pixel classification that include erroneous classifications.

FIG. 3(a) shows a satellite image of Diamond Lake.

FIG. 3(b) shows depth contours of the lake of FIG. 3(a).

FIG. 3(c) shows a labeling configuration that is not possible for a time step given the depth contours of FIG. 3(B).

FIG. 3(d) shows a cross-section of the lake of FIG. 3(a).

FIG. 4 provides a flow diagram for correcting classifications in accordance with one embodiment.

FIG. 5 shows the options for setting a water level given an ordered list of buckets and current land cover classification labels.

FIGS. 6(a)-6(c) depict a three-dimensional matrix for classifying a plurality of locations over a time sequence.

FIG. 6(d) depicts a two-dimensional matrix for classifying a plurality of locations over a time sequence.

FIG. 7(a) depicts a two-dimensional matrix showing noiseless classifications before the locations have been ordered based on elevation.

FIG. 7(b) depicts a two-dimensional matrix showing the classifications of FIG. 7(a) after the locations have been ordered to satisfy an elevation constraint.

FIG. 7(c) depicts a two-dimensional matrix showing noisy classifications before the locations have been ordered based on elevation.

FIG. 7(d) depicts a two-dimensional matrix showing the noisy classifications of FIG. 7(c) after the locations have been ordered to satisfy an elevation constraint.

FIG. 7(e) depicts a two-dimensional matrix showing the ordered classifications of FIG. 7(d) after classifications that did not agree with a time sequence of water levels have been corrected.

FIG. 8 shows the options for setting a water level for a time step given a noisy classification input for the time step and a resulting corrected classification for the locations in the time step.

FIG. 9(a) provides an input matrix showing unordered locations.

FIG. 9(b) shows an elevation matrix based on selected water levels for each time step.

FIG. 10(a) provides a composite satellite image of Lake Mead.

FIG. 10(b) provides an image based on classifications generated by SELPh.

FIG. 11 shows the corrections provided by SELPh for three different time steps of Lake Abbe.

FIG. 12 shows a sectional view of a lake having two different concave surfaces.

FIG. 13 is a diagram of a satellite image classification system used in the various embodiments.

FIG. 14 is a block diagram of a computing device used in the various embodiments.

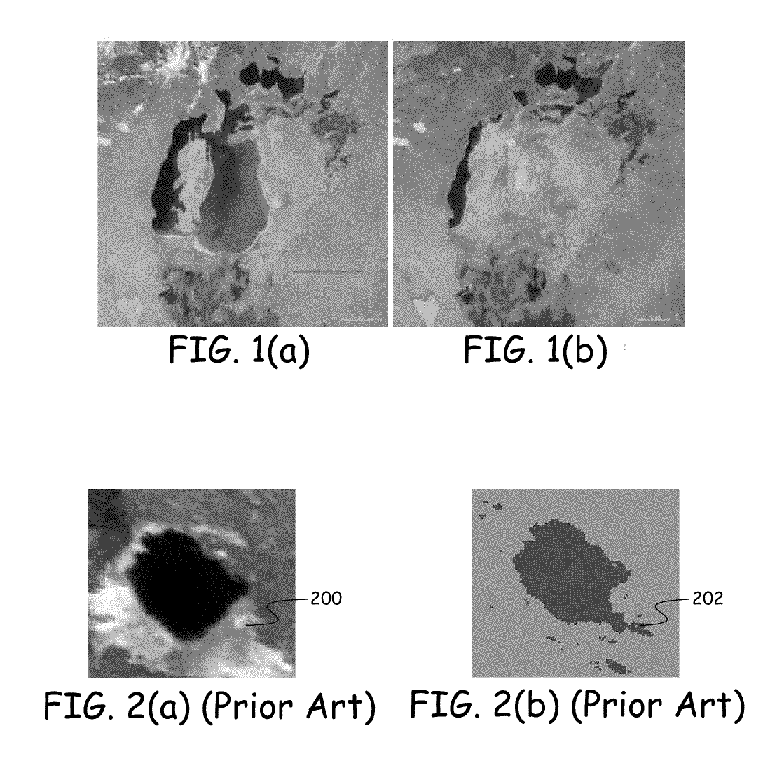

### DETAILED DESCRIPTION OF ILLUSTRATIVE EMBODIMENTS

There are primarily two approaches for lake surface monitoring. The first one is based on aerial and field surveys, which is extremely labor intensive and therefore infeasible for regularly updated global-scale monitoring. The other approach uses machine learning techniques for mapping the spatial extent of lakes using multispectral reflectance data from earth observing satellites. However, classifying pixels into water and land categories using classification models faces several challenges. In the multispectral feature space, water and land bodies can look very different at different locations (due to spatial heterogeneity), across time steps (due to seasonal changes) and even on consecutive dates (due to variations in atmospheric conditions such as clouds and aerosols). Hence, even the best classifiers (trained using high-quality, hand-picked training samples) can misclassify some land pixels as water and some water pixels as land. An illustration of the impact of such class confusion is presented in FIGS. 2(a) and 2(b) where FIG. 2(a) shows an example of a false color composite (reference image) and FIG. 2(b) shows a classified image of Lake Abbe, Ethiopia for the same time step using classification schemes of the prior art. In FIG. 2(a) the darkest areas are water and the lighter areas are land and in FIG. 2(b) the dark areas have been classified as water and the light areas have been classified as land. FIGS. 2(a) and 2(b) show that some patches of land (as indicated by a light area in FIG. 2) have been incorrectly classified in the water class by the prior art classifier. For example, land area 200 in the image of FIG. 2(a) has been misclassified as water 202 in FIG. 2(b).

One possible approach to address these issues is to use classification enhancement (CLEN), which aims to improve the labeling derived from initial (imperfect) classification, by using some implicit information related to the phenomena under consideration. A well-known example of CLEN approach is the spatial window majority filtering that is frequently used for image de-noising. It leverages the fact that adjacent pixels in an image are more likely to belong to the same class (this is also known as the first law of geography). In this method the majority class of a sliding spatial window is assigned to the center pixel. Similarly, Markov Random Field based approaches have also been used as a spatial CLEN strategy to produce homogeneous classification output that prefers same label for neighboring pixels and penalizes neighbors with different labels. While these approaches are effective in removing salt-and-pepper noise, they fail when there exists a significant level of spatial and temporal auto-correlation in the noise and missing data itself. This happens frequently in remote sensing images due to seasonal variations (that can result in temporally auto-correlated noise) and atmospheric conditions such as clouds and aerosols (that can result in spatially auto-correlated noise). For example in FIG. 2(b) one can see spatially correlated noise due to clouds that result in coherent patches of land pixels being incorrectly classified as water.

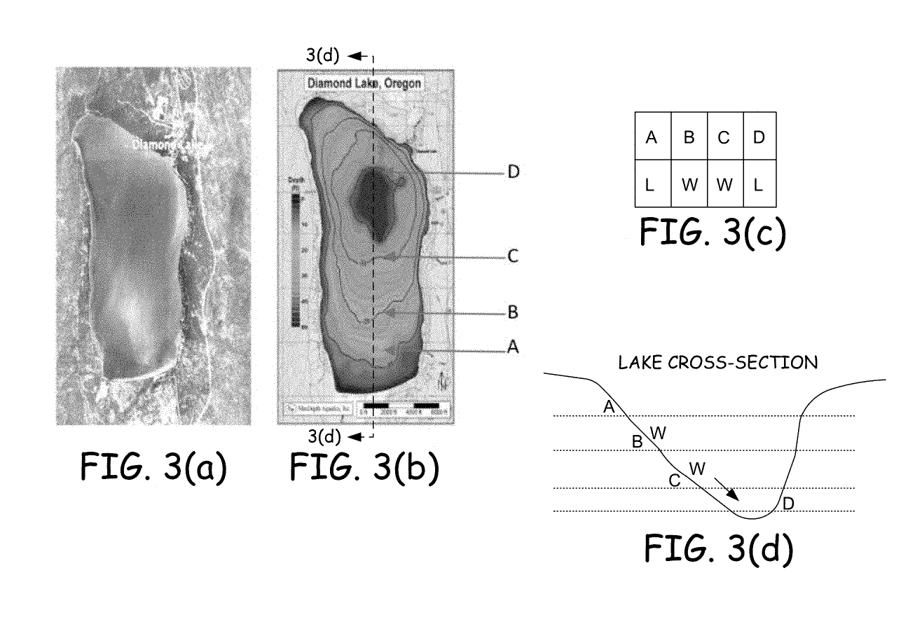

In accordance with the various embodiments, the classification output is constrained by some physical properties of the phenomena under consideration. The embodiments provide an approach that can leverage such constraints to address the limitations of traditional classification enhancement techniques mentioned above. As an example, in the application of lake surface monitoring, one such property is that locations at a higher depth in the lake have to be filled with water at a given time if any location at a lower depth has been filled with water at that time. FIGS. 3(b) and 3(d) shows illustrative examples of the depths of 4 locations (A,B,C,D) of a lake shown in FIG. 3(a). FIG. 3(b) shows depth contours and FIG. 3(d) shows a cross section of the lake in FIG. 3(a). In both FIG. 3(a) and FIG. 3(b), the depth at D is greater than the depth at C, which is greater than the depth at B, which is greater than the depth at A. The physical shape of the lake bed thus enforces that if location C is water at a given time then location D has to be water at that time. For example, the classifications shown in FIG. 3(c), where L stands for land classification and W stands for water classification, is not possible given the depths shown in FIGS. 3(b) and 3(d).

If the elevation information is available (e.g. in the form of depth contours), then it is possible to correct the imperfections in the labels simply by changing all labels above a certain height to land and below it to water such that it minimizes the number of disagreements with the input classification. However, in practice the precise information about the depth of locations is unavailable at appropriate spatial resolutions and at a global scale. The framework presented in the present embodiments allows us to make use of elevation-based constraints even when there is a complete absence of elevation information.

Note that if the true class labels (water/land) are available for multiple time steps, it is possible to infer the relative depth order between a pair of pixels. Specifically, if a pixel i is classified as water at more time steps than pixel j, then pixel i is at a deeper location than pixel j. But this does not help us since “true labels” is precisely the information we are trying to construct. Another possibility is to use imperfect input labels to estimate relative depth order between pixels. But the accuracy of this depth ordering depends upon the quality of the input labels. In particular, given an input classification with high levels of noise, the derived depth order will be extremely poor.

The embodiments described below have two building blocks—(1) estimate the most likely depth ordering from a given set of imperfect initial classification images at multiple time steps and (2) revise classification labels using a given depth order. More specifically, the embodiments simultaneously estimate both the depth ordering and enhanced classification product starting from a given imperfect classification product by iterating between the two tasks. Hence, this framework is referred to as Simultaneous Estimation of Labels and Physical properties (SELPh).

Below, the SELPh framework is described in the context of lake surface monitoring. However, the embodiments are not limited to lake surface monitoring and can be applied to simultaneously estimating the physical properties and class labels in many other domains. For example, satellite data is often used for land cover change monitoring by identifying pixels that show a change in their land cover class label in a certain time interval. The quality of change maps produced using this comparison approach depends on the accuracy of the land cover classification maps used. However, due to the data quality and heterogeneity issues discussed earlier, it is extremely challenging to obtain very high accuracy land cover classification products from satellite data. The imperfections in the land cover classification products often result in spurious changes being detected, i.e. a pixel shows a change in land cover class between two time steps due to misclassification in one of the time steps and not because of an actual land cover change. Moreover, because land cover changes are extremely rare, the spurious changes identified due to misclassifications can often dominate the true changes. The SELPh approach can be used in this application as well since the land cover change phenomena is governed by certain physical properties. One such property is that transitions between land cover classes is asymmetric, e.g. the probability of a forest being converted to urban land use is much higher compared to an urban pixel getting converted to a forest. If the transition probabilities between land cover classes are known, a Markov Model can be used to infer the improved class labels. However, since the transition probabilities are not known, one possible approach is to simultaneously estimate transition probabilities and true labels from given input sequences of imperfect classification labels. In general, the SELPh framework can be used in other applications where (1) physical properties can be used to correct the imperfections in the initial classification products, and (2) if clean labels are available, they can be used to construct the physical properties.

### Problem Setting

Objective: Leverage the physical properties of lakes in a CLEN strategy to improve the dynamic maps of their spatial extent.

Input: Raster thematic maps (P) of spatial extent of lakes, predicted by some “imperfect” classification model, over multiple time steps spanning several years. Each pixel has been assigned to one of the three classes: water (W), land (N) or missing (M).

Output: More accurate raster maps for each time step, produced by correcting misclassified instances and imputing missing labels. The label assignment in the output maps should be consistent with elevation-based constraints.

Constraints: Lake geometry constraints that require that if a location in the lake surface is assigned to water class (W) at time t, then all locations (connected to it) at greater depth should also be assigned to W for that time t.

The embodiments discussed below can be used with any input classification that provides reasonably high classification accuracy.

Due to misclassifications, the initial maps typically show inconsistency with the law of physics, i.e. there exist pairs of locations (loc₁, loc₂) for which at time

$${t}_{1} \{ {p}_{{loc}_{1}}^{{t}_{1}} = W \& {p}_{{loc}_{2}}^{{t}_{1}} = N \}$$

implying that loc₁ has greater depth than loc₂. This is contradicted at time step t₂ where

$$\{ {p}_{{loc}_{1}}^{{t}_{2}} = N \& {p}_{{loc}_{2}}^{{t}_{2}} = W \}$$

which implies that loc₂ has greater depth than loc₁. The final output from SELPh should resolve all such contradictions and produce physically consistent labeling.

Sections 1 and 2 below provide the details of two different embodiments that make use of SELPh concept in context of lake monitoring.

### Section 1. Ordered Graph Partitioning

In section 1.1 we present an embodiment for classification enhancement in scenarios where input classification maps have perfect classification accuracy but may suffer from large amounts of missing labels. This approach uses an ordered graph partitioning formulation of the input classification maps to infer relative depth ordering and later uses the inferred depth ordering for imputing missing labels. However, in practice the input classification maps are plagued with misclassifications as a consequence of confusion between classes. The approach to infer depth order presented in section 1.1 does not work for such scenarios. In section 1.2 an embodiment is described that allows simultaneous estimation of depth ordering and classification enhancement from classification maps with misclassified instances.

### 1.1 Correct But Incomplete Multi-Temporal Image Classification

Correct but incomplete image classification refers to an input classification in which the class label pᵢ^{t} for pixel i at time step t, when available, is always correct. However, for several pairs of (i,t) the label is missing in the input classification. The goal here is to correctly impute the missing labels of these instances.

One embodiment first estimates the depth order among pixels from the incomplete input classification. Once the most likely depth order is obtained, then for each time step the missing labels are imputed based on the estimated depth order and the input labels of the labeled instances.

### Estimating Depth Order

Given a correct but incomplete image classification at every time step, the input labeling bears information on the relative depth order/elevation order between pixels. For example, if pixel i is labeled as W and pixel j is labeled as N at any particular time step t, then it is confirmed that pixel i is at a greater depth than pixel j. To obtain the depth ordering, we first construct a directed graph G=(V, E), where the set of vertices (V) corresponds to the pixels of the image and the set of edges (E) capture the relative depth relationship between a pair of pixels; the edge eᵢⱼ from node i to node j exists if and only if at some time step pixels i is labeled as W and pixel j is labeled as N. Since the input labeling is “correct”, it is expected to follow the law of gravity at all time steps, i.e. there would be no contradictions regarding the ordering between two pixels across different time steps. In graph G, this would imply that for any pair of nodes (i, j) only one of the two directed edges can exist: eᵢⱼ or eⱼᵢ. In fact, graph G is a directed acyclic graph for this problem setting.

We formulate the problem of inferring the depth ordering/relative elevation ordering as one of arranging the vertices V such that all the edges in G are forward edges in the ordering, i.e. for all edges eᵢⱼ ϵ E agree with the depth order. The depth ordering among pixels is estimated using topological sort on the graph G. The topological sort problem is defined as: given a directed acyclic graph G=(V, E), find a linear ordering of vertices (V) such that for all edges eᵢⱼ ϵ E, i preceeds j in the ordering. (see Algorithm 1 for the pseudo-code of topological sort used in our approach).

Algorithm 1 Estimating depth contours (bucket order) From “correct
but incomplete” input classification using topological sort

Require: initial multi-temporal classification P

// construct graph G = (V,E) from input classification P
V is set of all pixels
E ← Ø
T ← number of time steps in P
for t=1 to T do

for all (i,j) pairs of pixels do

if {pᵢ^{t} = W & pⱼ^{t} = N} then

E = E ∪ eᵢⱼ

end if

end for

end for
// infer bucket order from G
Bucket order B ← Ø
i=1
compute indegree of each node in V
while V ≠ Ø do

Bᵢ ← v, ∀v ϵ V with indegree=0
remove nodes v from graph G
update indegree of the remaining nodes V−v
i=i+1

end while

In reality multiple pixels may have the same depth, i.e. belong to the same depth/elevation contour. Due to such grouping structure present in data, the ordering relationship among pixels is more appropriately represented by a bucket order rather than a total order. A bucket order is a special case of partial orders in which each bucket consists of multiple entities (e.g. in our case pixels) with no order among themselves and there exists a total order among the buckets. In fact, topological sort on G in our application gives a bucket order, in which each bucket of the bucket order corresponds to a depth contour of the lake.

### Estimating Missing Labels

Since all the members of a bucket are at the same depth, in the output labeling for any given time step they will either be all W or N. Moreover, since the input classification is always correct (with missing labels), for any given time step, all the initially labeled pixels of a bucket would have the same label (either W or N). Thus, the label of buckets with any labeled member pixel can be inferred, and subsequently the pixels with missing label in these buckets are assigned the label of their bucket. However, it is possible that no member of a bucket is labeled in the input classification at a particular time step. The labels of such buckets can be inferred based on the total ordering constraint among the buckets, which is enforced at every time step. The total ordering constraint implies that at every time step, all W buckets appear before the start of the first N bucket. Thus, if a bucket with no labeled member pixel has a preceding N bucket it should be assigned to N class, else to the W class. The pixels are then assigned the label of their bucket.

### ILLUSTRATIVE EXAMPLE

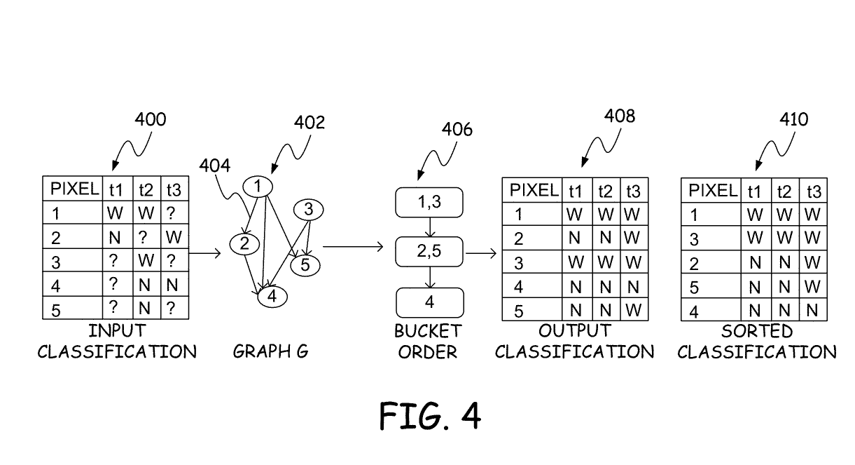

To further clarify the approach discussed above, FIG. 4 shows a schematic for estimating depth order and final labels from correct but incomplete input image classification using the topological sort method in accordance with one embodiment.

First, graph G 402 is constructed from the input classification 400 by adding edges between pairs of nodes if at any time step one of them is labeled as W and the other is labeled as N. For example, the edge e₁₂ 404 is added due to time step t1. Next, to obtain the bucket order using the topological sort algorithm, we search for nodes with no incoming edges in G (in this example nodes 1 and 3) and put them in the first bucket. Next, all edges from these nodes are removed from graph G and the next set of nodes with no incoming edges are put in the next bucket. This process is repeated till G is empty. This gives us a bucket order 406 that corresponds to the depth contours in our application. Finally, to obtain the output classification, for each time step, the instances of every bucket are inspected to identify the label for the bucket. For example, at time step t1, the top bucket (consisting of pixel 1 and 3) is assigned to W since pixel 1 ϵ top bucket is classified as W at t1 in the input classification. Similarly, middle bucket is assigned to N as pixel 2 is assigned to N at t1. However, the instance of bottom bucket is not labeled in the input labels at time t1. But the total order among the buckets constrains that if middle bucket is N for a given time step, then all subsequent buckets (which are expected to have lower depth) must be assigned N for that time step. Hence, the bottom bucket (which contains pixel 4) is assigned to N class at time t1. Repeating these steps results in an output classification 408 that provides a classification for each pixel at each time point. The pixels can then be reordered to indicate their depth relative to each other based on these classifications resulting in a sorted classification 410. In sorted classification 410, pixels are ordered such that a pixel that is listed below a given pixel has the same depth or has a greater depth than the given pixel.

### 1.2 Noisy and Incomplete Multi-Temporal Image Classification

Noisy and incomplete image classification refers to an input classification in which the class label pᵢ^{t} corresponding to pixel i at time step t may be incorrect. Moreover, for several pairs of (i,t) the label is missing in the input classification. The goal is to re-assign labels to all instances such that the missing labels are correctly imputed and the incorrect labels are re-assigned to their correct class in the final output classification.

### Estimating Depth Order

This embodiment models the pairwise information on relative depth of pixels as a directed graph G=(V, E). The set of vertices (V) corresponds to the pixels of the image. The set of edges (E) capture the relationship between a pair of pixels at each time step; eᵢⱼ^{t} is the edge from node i to node j at time t. We compute the graph G by adding the edges eᵢⱼ^{t} between pairs of nodes i and j as follows:

$${e}_{ij}^{t} = \{ \begin{matrix}1 & if {p}_{i}^{t} = W \& {p}_{j}^{t} = N \\ 0 & otherwise\end{matrix}$$

In case of noisy input classification there may exist pairs of locations (i,j) and time steps (t₁, t₂) for which at time t₁ {pᵢ^{t}^{₁}=W&pⱼ^{t}^{₁}=N} that adds edge eᵢⱼ^{t}^{₁} to G, and at time t₂ {pᵢ^{t}^{₂}=N&pⱼ^{t}^{₂}=W} that adds edge eᵢⱼ^{t}^{₂}. This creates cycles in graph G, and due to the presence of cycles in graph G, there may not exist any ordering B, such that all the edges in G are forward edges in the bucket order, i.e. for all edges eᵢⱼ^{t} ϵ E the bucket of i in B precedes the bucket of j in B.

### Mathematical Formulation

This embodiment formulates the problem of estimating depth order from graph G as a maximal K-ordered graph partitioning problem: assign the vertices to one of the K ordered buckets (partitions) so as to maximize the number of edges in G that agree with the ordering (forward edges) minus the number of edges that disagree with the ordering (backward edges).

Consider a given bucket order B with K buckets. The forward set F of B is defined as the set of directed pairs (i, j) such that i ϵ Bₘ and j ϵ Bₙ and m<n. Similarly, the backward set R is defined as the set of directed pairs (i, j) such that i ϵ Bₘ and j ϵ Bₙ and m>n. Then our mathematical objective for searching the maximal K-ordered partitioning (bucket order) can be written as

$${max}_{B} {\sum }_{t = 1}^{T} [ {\sum }_{( i , j ) ∈ F} {e}_{ij}^{t} - {\sum }_{( i , j ) ∈ R} {e}_{ij}^{t} ]$$

$$s . t . \# buckets in B = K$$

### Algorithm

Consider a special case of the above objective where the value of K=2, i.e. the goal is to split the graph into exactly two partitions. The optimal solution for this special case can be computed in O(V+E) time. However, there is no existing polynomial time algorithm to find the optimal bucket order for the case K>2.

Therefore, to solve the objective for K>2, the various embodiments use a heuristic approach that starts with all nodes placed in a single bucket and then iteratively increases the number of buckets by splitting one of the buckets in the current bucket order till the bucket order has the desired number of buckets (i.e. K). More specifically, at each iteration, the optimal split and splitgain (the value of the objective corresponding to optimal split) is computed for every bucket in the current bucket order. Then, the bucket that has the maximum splitgain is split into two, thereby increasing the size of the bucket order by one bucket at every iteration. This split makes each of the two resulting buckets more homogenous than the bucket being split. This iterative procedure is continued until a bucket order with the desired number of buckets is reached. Note that this algorithm makes greedy (locally optimal) splits at each iteration to reach the desired number of buckets. In particular, the algorithm divides a bucket so as to maximize the number of water levels between each bucket across the time sequence. In other words, the algorithm divides the bucket that has the largest number of dissimilar land cover labels across the time sequence as evaluated on a time step by time step basis. However, the greedy strategy is only a heuristic and does not guarantee global optimality of the bucket order obtained. The detailed pseudo-code for this step is provided in Algorithm 2.

Algorithm 2 updateBucketOrder (X,numbuckets)

Require: current multi-temporal classification X and

numbuckets
buckets ← 1
B_{{1}}←V //Initially all pixels are put in single bucket
// loop till size (B) is numbuckets, increasing 1 bucket at
each iteration
while buckets < numbuckets do

// select the bucket with maximum split gain
for k=1 to buckets do

// construct graph G for members of Bₖ
E←Ø
for t=1 to T do

for all (i,j) location pairs of members of bucket
Bₖ do

if {xᵢ^{t} = W & xⱼ^{t} = N} then

E = E ∪ eᵢⱼ^{t}

end if

end for

end for
// compute split gain
for each edge eᵢⱼ^{t} do

delta (i) ← delta(i) +1
delta(j) ← delta(j) −1

end for
gain(k) = sum(delta(delta > 0)

end for
splitbucket ← argmax (gain)
// splitting B_{splitbucket}
Bⱼ₊₁ ← Bⱼ; ∀j > splitbucket
B_{splitbucket+1} ← members of B_{splitbucket} with +ve delta
B_{splitbuck} ← members of B_{splitbucket} with −ve delta
buckets ← buckets +1

end while

### Estimating Labels

Once an ordered list of location buckets has been formed, estimates of the water level at each time step can be made. The water level at a time step represents the boundary between buckets that contain predominantly land locations and buckets that contain predominantly water locations. For a given bucket order with k buckets, out of the 2^{k} options for labeling buckets with W or N class, there are only k+1 options that enforce the total order constraint among buckets imposed by gravity. Thus, there are only k+1 options that will label all bucket below the water level as water and all buckets above the water level as land.

Due to errors in the current location classifications or differences between locations assigned to a same bucket, a bucket may contain both land and water labels at a time step. Setting the water level above such a bucket is an assertion that the land labels in the bucket are incorrect and setting the water level below such a bucket is an assertion that the water labels in the bucket are incorrect.

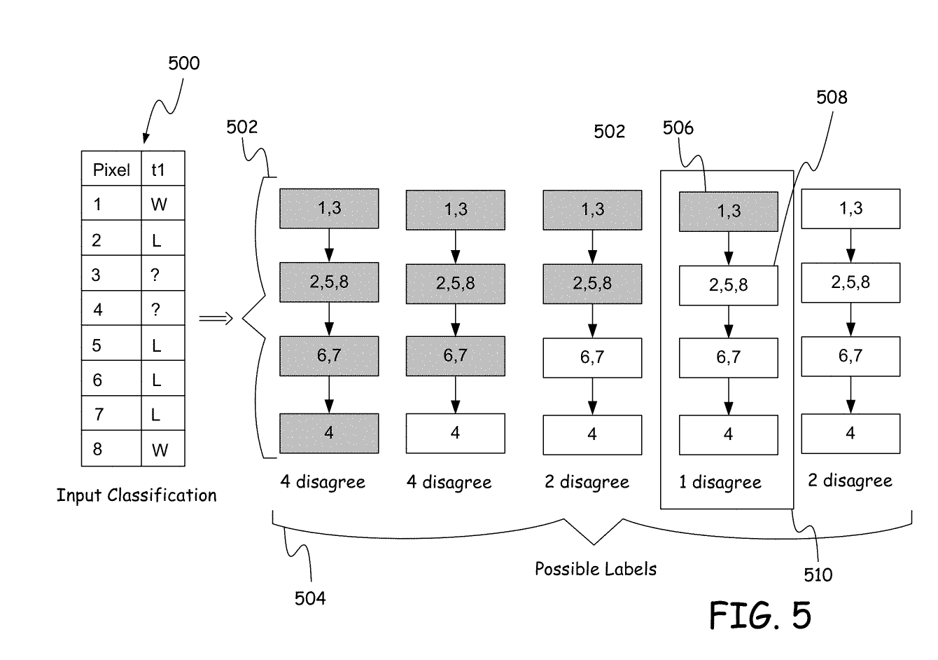

To select the bucket labeling from the k+1 options, at each time step, we count the number of labels in the buckets that will disagree with label assigned to the bucket for each of these k+1 bucket labels. The bucket labeling corresponding to the minimum number of disagreeing labels is then chosen thereby setting the water level above the top-most bucket labeled as water for the time step. This produces a time-sequence of water levels. FIG. 5 shows an illustrative example of how this step labels the buckets corresponding to a given set of location classifications and bucket order. In FIG. 5, an input classification 500 has been used to identify buckets of pixels 502 in a bucket order. Given the bucket order, there are five labeling options 504, where each labeling option depicts a water label W as a dark bucket, such as bucket 506, and a land label N as a white bucket, such as bucket 508. For each of these options, the number of disagreements with the input classification is computed, and the bucket labeling with minimum number of disagreements 510 is selected.

The time-sequence of water levels provides some information about the proper labels for the locations in each bucket. In particular, for buckets that are located far below the water level at a time step, it is expected that all of the locations in the bucket should be labeled as water for the time step. Similarly, for buckets that are located far above the water level at a time step, it is expected that all of the locations in the bucket should be labeled as land for the time step. However, for buckets that border or are close to the water level it is not as clear that all locations below the water level should be labeled as water and that all locations above the water level should be labeled as land because it is also possible that one or more locations have been assigned to an incorrect bucket.

In one embodiment, these two observations are utilized to update the labels for some but not all of the locations at each time step. In particular, the embodiments change the labels of locations in a bucket to match the label assigned to the bucket if, and only if, the bucket is separated from the water level by at least a minimum number of other buckets, referred to as a buffer. For instance, if the buffer is set to “1”, then at least one bucket must be between a candidate bucket and the water level in order for the locations of the candidate bucket to all be set to the label assigned to the candidate bucket. In this example, if a bucket is next to the water level, it would not be separated enough from the water level and all of the classifications for the locations in that bucket would be maintained. The size of the buffer can be set as desired and can either be fixed or can change based on the number of iterations (described below) that have been performed.

The pseudo-code for this step is provided in Algorithm 3.

Algorithm 3 updateLabels (X,B)

Require: current multi-temporal classification X and current

bucket order B
T ← number of time steps in X
k ← number of buckets in B
for t=1 to T do

// select bucket (depth contour) at the boundary of W
and N by computing disagreements for each possible
boundary bucket
for i=1 to k do

inwater ← ∪ Bⱼ, ∀j < i
inland ← ∪ Bⱼ, ∀j > i
disagree(i) ← #{X(inland, t) = W} + # {X(inwawter,t)
= N}

end for
boundary ← argmin (disagree)
// update labels of X at time t using selected boundary
inwater ← ∪ Bⱼ; ∀j < boundary −buffer
inland ← ∪ Bⱼ; ∀j > boundary+buffer
X (inwater, t) ← W
X (inland, t) ← N

end for

### Simultaneous Estimation of Labels and Depth Ordering

Given the method to estimate bucket order B from noisy input classification P (Algorithm 2), one option is to first get the best estimate of B and then estimate the final output classification from B and P using the method described in Algorithm 3. Our results in Section 4 show that using this approach leads to significant increase in classification accuracy compared to the input P. In particular, the constraint on class labels imposed by the estimated bucket order helps in correctly imputing the missing labels and correcting some of the misclassifications in the input P.

The correctness of the estimated bucket order B depends on the level of noise in P. Thus, for an input P with a high level of noise in input labels, the bucket order obtained using (Algorithm 2) is likely to suffer from incorrect ordering among pixels. This incorrect ordering in B impacts the accuracy of the final output—i.e. it impedes the correction of some misclassifications and even worse may lead to incorrect flipping of labels of some instances that were correctly labeled in P.

In accordance with some embodiments, this issue is addressed by doing a simultaneous estimation of labels (output classification) and physics (depth order). In particular, the embodiments use an iterative scheme in which instead of estimating the final bucket order at the very first iteration, the granularity of the bucket order (i.e. number of buckets in B) is gradually increased at every iteration based on a current sequence of estimated water levels and their associated classifications. With each increase in the granularity of the bucket order, a new sequence of water levels is estimated and is used to update the classifications of locations in at least some of the buckets (depending on the size of the buffer used in algorithm 3) and based on constraints imposed by the current bucket order and a current estimate of the water level. Thus, at every iteration, both the uncertainty in bucket order (inverse of the number of buckets) and the imperfection in the classification (number of missing labels and misclassified instances) is reduced. In fact, the reduction of uncertainty in B (i.e. increase in number of buckets in B) helps in reducing the imperfections in classification by adding more physics-based constraints. Similarly, using the classification at current iteration (which has less imperfections than P) decreases the chance of introducing incorrect ordering among pixels as the number of buckets in B is increased. Our results in Section 4 confirm that the iterative approach, which leverages the feedback between the estimation of labels and physics, has a significantly higher classification accuracy compared to the sequential approach. The pseudo-code for this step is provided in Algorithm 4.

Algorithm 4 SELPh on “incorrect and “incomplete”
input classification

Require: initial multi-temporal classification P

// update bucket order and class labels,
// increasing the number of buckets in each iteration
X ← P // X is the updated labeling at current iteration
numbuckets ←1
B_{{1}} ← V // Initially all pixels are put in single bucket
T ← number of time steps in P
while numbuckets < T do

numbuckets ← numbuckets +1
B ← updateBucketOrder (X, numbuckets)
X ← updateLabels (X,B)

end while

### Approach 2: Profile Matching

Now, we describe a second embodiment of SELPh for lake extent monitoring.

### 3.1 Input

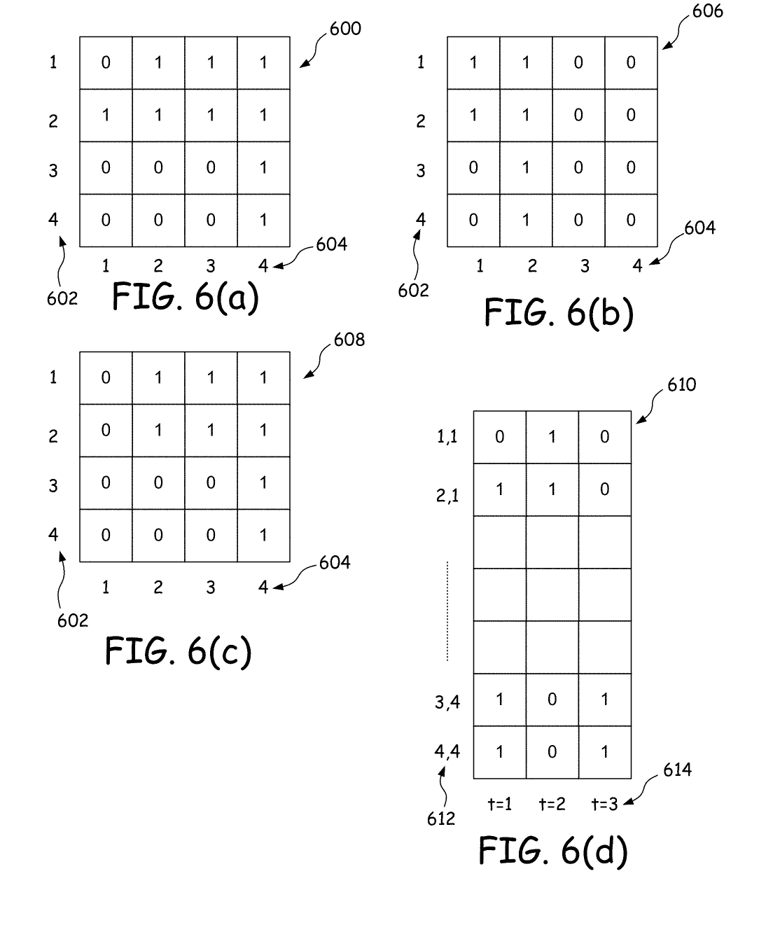

Classification maps of a region across multiple time steps are given as inputs. The matrix A_{R×C×T} represents the input data in the 3-dimensional form where A_{i,j,t} ϵ [0, 1] represents the class label (0 means land, 1 means water) of a pixel at location (i, j) on the grid at time t. Alternatively, matrix A can be represented as a 2-dimensional matrix D_{N×T} where N is the total number of locations (R*C) and D_{l,t} is the class label of pixel at location index l at time t. From here on, the cells of the grid will be referred to as locations and a (location, timestep) pair defines a pixel. Each row of matrix D represents the temporal sequence of class labels of a location. Since each time step is a binary classification map with noise, each column of D represents a noisy bipartite grouping of the given N instances. FIGS. 6(a)-6(d) show an illustrative example of these two data representations with FIGS. 6(a)-6(c) showing a three-dimensional matrix with a separate two-dimensional matrix for each of three time steps and FIG. 6(d) showing a two-dimensional matrix with each row representing a geographic area or geographic location. Specifically, two-dimensional matrix 600 of FIG. 6(a) provides land/water classifications (0/1) for pixels described by a vertical coordinate 602 and a horizontal coordinate 604 for time point t=1, two-dimensional matrix 606 provides land/water classifications for the same pixels as matrix 600 for time point t=2, and two-dimensional matrix 608 provides land/water classifications for the same pixels as matrix 600 for time point t=3. In matrix 610 of FIG. 6(d), each pixel, identified by its vertical, horizontal coordinate pair 612, is assigned a row with the land/water classifications for the pixel at different time points 614 being shown in each column of the row. For the proposed approach discussed below, the 2-dimensional data representation of FIG. 6(d) is used. Given this input, the embodiment detects and corrects inconsistently/incorrectly labelled pixels.

2.2 Physical Constraint through Elevation

This embodiment uses elevation constraint to improve the accuracy of labels. Locations have an inherent ordering based on their elevation. Specifically, if location l is filled with water then all locations that are deeper (lower elevation) than location l should also be filled with water. Given this constraint through ordering, imperfect labels can be estimated and subsequently corrected.

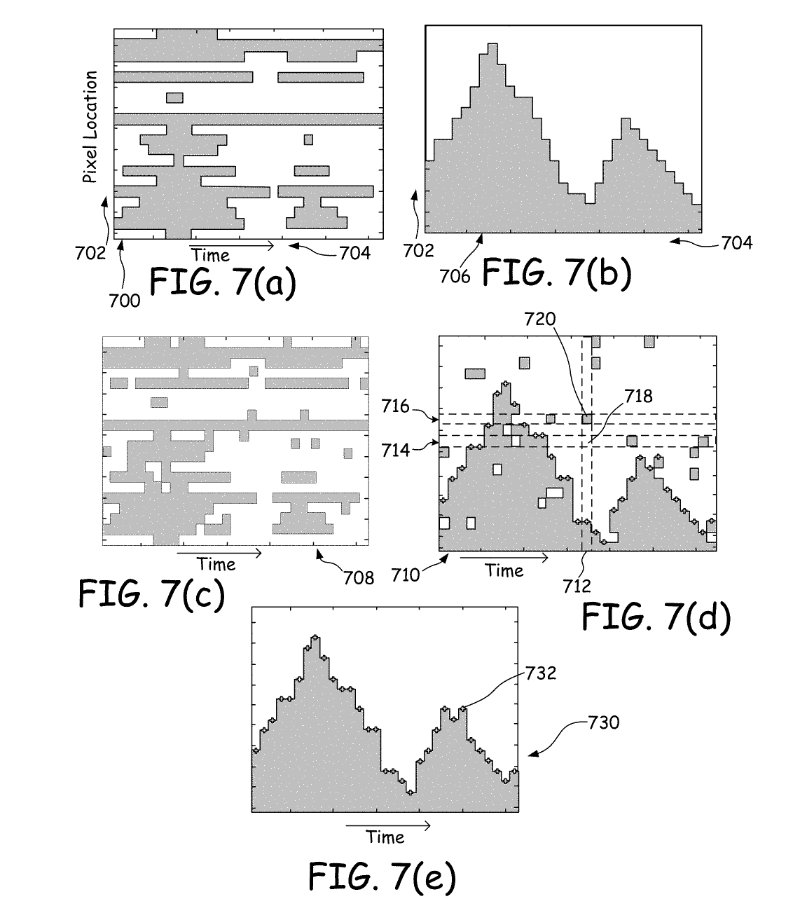

FIG. 7(a) shows a pure synthetic input matrix Dₚ 700 with N=100 locations distributed along vertical axis 702 and T=200 time steps distributed along horizontal axis 704 and with darker blocks representing water pixels and lighter blocks representing land pixels. In FIG. 7(a), the pixels have not been ordered to reflect their proper relative elevation however the pixels are all correctly labeled. Each row of input matrix Dₚ represents a temporal sequence of class labels for a pixel location. FIG. 7(b) shows the matrix Dₚ^{π} 706 that is obtained by ordering locations in Dₚ in increasing order of their elevation. The locations are still distributed along vertical axis 702 but are now ordered such that the bottom of matrix 706 represents the location at the lowest elevation and the top of matrix 706 represents the location at the highest elevation. The same time steps are shown on horizontal axis 704 of matrix 706 as are shown for matrix 700.

This ordering of information through elevation is referred to as π. After the ordering, by definition for all time steps, all water pixels have lower elevation than land pixels. FIG. 7(b) also shows the varying nature of bipartite groupings. This varying amount of water pixels in different time steps corresponds to growing and shrinking of a water body across time.

FIG. 7(c) shows a matrix Dₙ 708, which is a noisy version of Dₚ matrix 700, i.e. a matrix in which bipartite groupings are not pure. FIG. 7(d) shows matrix Dₙ^{π} 710, which is obtained by ordering locations using π. As shown in FIG. 7(d), elevation based ordering has reasonably partitioned water and land labels for different time steps. However, there are some location pairs that are showing physically inconsistent behavior in some time steps. For instance, in time step 712 a lower elevation (deeper) location 714 has been labeled as land 718 where a higher elevation (shallow) location 716 has been labeled as water 720. Hence, using the elevation ordering, these inconsistencies can be detected and could be corrected to form the labels shown in FIG. 7(e). However, an issue here is that we still have no idea whether the inconsistency is due to location 716 being incorrectly labeled as water or location 714 being incorrectly labeled as land.

2.3 Estimation of Correct Labels from Elevation

If elevation ordering (π) and size of one partition in bipartite grouping of a time step t (henceforth referred as θₜ) are available, then inconsistent labels can be estimated and corrected for that time step. Without the loss of generality, the partition that contains water pixels is used in the embodiments described below. For instance, θₜ=k would mean that for time step t, bottom k locations in π are filled with water. This would automatically mean that for time step t, top N−θₜ locations in π are land where N is the total number of locations. In other words, θₜ represents water level at time step t in our application or θₜ induces the true bipartite grouping in that time step. Now, if there are locations in bottom θₜ in π that are labelled as land at time step t, then they have been incorrectly labelled as land in that time step. Similary, if there are locations that are in top N−θₜ in π that are labelled as water in time step t, then they have been incorrectly labelled as water. Hence, given π and θₜ incorrectly labelled locations on the given time step can be estimated.

Unfortunately, θₜ is a latent variable and it has to be estimated as well because the data (bipartite groupings) is noisy. In accordance with one embodiment, the maximum likelihood interpretation of θₜ is used as the estimate for θₜ. Specifically for a given ordering, a value of θₜ will be selected that leads to the smallest number of incorrectly labelled locations on that time step. In other words, a value of θₜ is chosen that best describes the given bipartite grouping on that time step. Mathematically, \hat{θ}ₜ is estimated as

\hat{θ}ₜ=_{kϵ[O,N]} Acc(k, t, \hat{π}) (1)

where

$$Acc ( k , t , \hat{π} ) = {\sum }_{i = 0}^{k} 1 ( {D}_{n}^{\hat{π}} ( i , t ) == 1 ) + {\sum }_{i = k + 1}^{N} 1 ( {D}_{n}^{\hat{π}} ( i , t ) == 0 ) \qquad ( 2 )$$

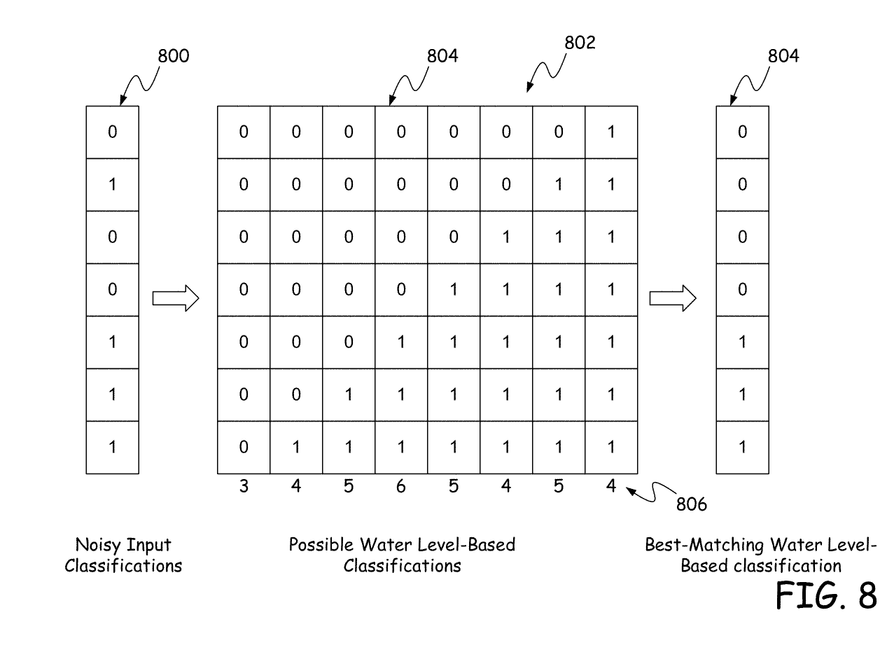

In the equations above, Acc is an accuracy measure that indicates the number of pixels that have the same label that is provided for the pixel by the bipartite grouping given water level θₜ and location level ordering \hat{π}. The first term on the right side of equation 2 measures the agreement of estimated water partition with the noisy water partition and the second term measures the agreement of the estimated land partition with the noisy land partition. Note that the maximum likelihood estimate of \hat{θ}ₜ is applicable only when majority of the labels are correct. In other words, if a majority of the labels are wrong then no method has any hope of correcting the errors. FIG. 8 shows an illustrative example demonstrating estimation of \hat{θ}ₜ. In FIG. 8, a noisy input classification 800 is obtained where 1 represents water and 0 represents land. Noisy classification 800 is then compared against each of a set of possible water-level based classifications, where each water-level based classification has a different position for the water level, k, all pixels below the water level are classified as water and all pixels above the water level are classified as land. In particular, the number of matching classifications 806 between noisy classification 800 and each of the water-level based classifications 802 is determined. The water-level based classification with the largest number of matching classifications 804 is then selected. Thus, for the given example, k=3 in classification 804 leads to maximum agreement with the noisy input partition with Acc value of 6.

FIG. 7(e) shows the matrix P^{π,\hat{θ}} 730 that represents estimated bipartite groupings using equation 1 on Dₙ^{π}. Diamond markers on each time step, such as marker 732, mark the partition boundary for which estimated partitions showed maximum agreement with noisy partitions. Hence, by definition, for any given time step, locations below diamond markers are labelled as water and locations above the marker are labelled as land. Now, given matrix P^{π,\hat{θ}}, 730 we can resolve the ambiguity mentioned in the end of section 2.2. Specifically, from P^{π,\hat{θ}}, we can say that in Dₙ^{π} on time step t, location i was incorrectly marked as water and not location k.

2.4 Estimation of Elevation from Perfect Labels

The previous section describes how accurate elevation information can be used to estimate correct labels. Similarly, accurate class labels (bipartite groupings) can also be used to estimate inherent elevation information. Physically consistent variation in class labels due to dynamics in water body can be used as a proxy to estimate order. Specifically, over any given time period a deeper location will be labeled as water more frequently than a shallow location. This is due to the physics described in section 2.2 above. Whenever a shallow location is water then the deeper will strictly be water. But if a deeper location is water then a shallow location may or may not be water depending on current extent of the water body. Mathematically, elevation of a location is directly proportional to the number of time steps in which the location is labeled as water. Specifically, this relationship is defined as

$${EE}_{l} = T - {\sum }_{t = 1}^{T} ( 1 ( {D}_{p} ( l , t ) == 1 ) \qquad ( 3 )$$

where,
EEₗ is the estimated elevation of the location l, and T is the number of time steps.
   2.5 Estimation of Elevation from Noisy Labels

Till now, we have assumed that either accurate elevation information is available or accurate labels are available. But in our application setting, labels are noisy and even elevation information is not available. EE will only be an approximation of the true hidden elevation information under the noisy labels scenario. In later sections, it is shown that this is a poor approximation of the elevation information.

Hence, a better way to aggregate these noisy bipartite groupings is needed so that a better approximation of inherent ordering (henceforth referred to as \hat{π}) can be made, which will subsequently lead to better label correction capability. In accordance with one embodiment, an objective function is defined that guides the search for the better approximation of the true ordering. Mathematically, the objective function is defined as

$$\hat{π} {\sum }_{t = 0}^{T} Acc ( {\hat{θ}}_{t} , t , \hat{π} ) \qquad ( 4 )$$

As mentioned before, Acc is calculated with respect to a given ordering and for a time step. It measures the agreement between the estimated bipartite grouping and input bipartite grouping. So the above objective function would prefer the ordering that leads to overall better agreement between estimated and input bipartite groupings. In other words, the embodiments prefer an ordering that overall describes the data well. This objective function extends the maximum likelihood interpretation from a single time step to the whole data. As explained in section 2.3, if elevation is given, \hat{θ} can be estimated. But in this embodiment elevation is also a variable. Hence, in the above function there are two latent variables, \hat{θ} and \hat{π}.

Now, to obtain an ordering that best fits the given data or maximizes the above objective function is a NP-Hard problem that cannot be solved directly. Instead, the present embodiments provide heuristic solutions to estimate the approximate ordering. This approach (henceforth referred to as Profile Matching) uses an EM like framework that iteratively improves quality of approximate ordering with respect to the above objective function.

### 2.6 Proposed Approach: Profile Matching (PM)

As explained in section 2.3, if an ordering (π) is available, water levels (\hat{θ}ₜ) and subsequently correct labels can be estimated for each time step. On the other hand if correct labels are available (section 2.4) then elevation information can be accurately estimated. Profile Matching iterates between estimating water levels from a given ordering and estimating new ordering from the water levels such that new ordering has improved value of the objective function than the previous ordering. The two steps are explained below

2.6.1 Estimating Water Levels from Ordering

This step is very similar to the step explained in section 2.3. The only difference here is that the current estimate of ordering (\hat{π}) is used instead of true ordering (π) because the true ordering is not known. To initialize the process, any random ordering can be provided (\hat{π}⁰). So, water levels at iteration i are calculated as

\hat{θ}ₜⁱ=_{kϵ[O,N]} Acc(k, t, \hat{π}ⁱ⁻¹) (5)

2.6.2 Estimating Ordering from Water Levels

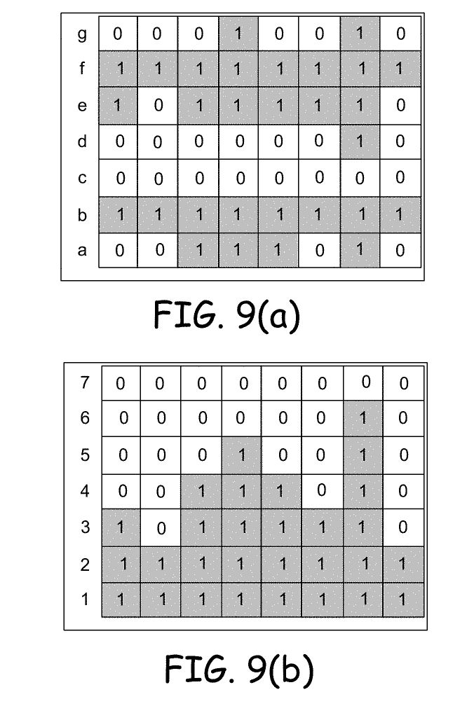

In this step, a new ordering of the locations is determined using the estimated water levels at each time t. This reordering involves the use of location profiles and elevation profiles. As mentioned in section 1.2, a location profile is basically the temporal sequence of class labels of a given location. Now, consider the matrix shown in FIG. 7(e). As mentioned earlier, Pₙ^{θ,π} is obtained with respect to a given ordering. This matrix can also be viewed from a different perspective. Each column (time step) of Pₙ^{74 ,π} represents the estimated bipartite partition for the given column (time step). On the other hand, each row of Pₙ^{θ,π} represents the ideal temporal sequence of labels for that row (elevation). To re-emphasize, i^{th} row of Pₙ^{θ,π} represents the ideal label sequence of i^{th} ranking elevation for the given ordering π. Note that there is a distinction between a location and its elevation. Ideally, a location will be assigned to an elevation such that the location's profile and the corresponding elevation's profile have maximum agreement. For instance, comparing an input matrix of FIG. 9(a) with an elevation matrix based on water levels of FIG. 9(b), location f of FIG. 9(a) has 6 mismatches with the 5th ranking elevation's profile of FIG. 9(b) but location f has 0 mismatches with the 1st ranking elevation's profile. Hence, it makes sense to assign location f to elevation 1 rather than elevation 5. To summarize, each location is assigned to an elevation with which it has maximum agreement. If there are multiple elevations for which a location is showing maximum agreement, then ties can be broken arbitrarily. Similarly, multiple locations can be associated to a single elevation. Since elevation profiles are already elevation ordered by definition, this assignment process produces partial ordering where instances associated with a higher ranked elevation profile will be ranked higher than instances associated with lower ranked elevation profile. To break ties within locations that are assigned to the same elevation, the locations are ranked then according to their EE rank as there is other information available for those locations. This gives a new complete ordering of locations. Note that in the embodiment above, the number of elevations is selected to match the number of locations.

The algorithm iterates between these two steps, determining a water level for each time stamp t using a current order for the locations and reordering the locations based on the new water levels, until there is no further increase in the value of the objective function.

3 Evaluation

In this section the performance of SELPh approaches are analyzed and compared with other baseline algorithms for classification enhancement. In particular, the ordered graph partitioning approach is analyzed since it is more general than profile matching and works with missing data. Due to the absence of ground truth of lake surface dynamics, it is infeasible to provide quantitative evaluation on real lakes. Therefore, quantitative evaluation is provided below based on synthetically generated lake dynamics data along with two case studies on real lakes.

### 3.1 Synthetic Data Experiments

### 3.1.1 Generation

1) Extent and Dynamics: First, the extent for different time steps are created such that the dynamics in the lake is physically consistent i.e. the synthetic water body grows and shrinks according to the predefined inherent ordering of locations. This set of extent maps are the ideal maps to be recovered after label correction. Hence, they will be used as ground truth to compare the performance of various algorithms.

2) Noise Structure: Noise is introduced in the ground truth extents to create the dataset that will be provided as input to different algorithms for correction. Noise can have different characteristics and hence will impact algorithms differently. Below, three types of noise structures are analyzed

Random Noise (RN): (location, time step) pairs i.e. pixels are randomly selected and noise is added in those pixels.

Spatial Noise (SN): Pixels are randomly selected as seed pixels around which spatially auto-correlated noise is added. The spatially auto-correlated noise is added only into the time step to which that pixel belongs.

Spatio-temporal Noise (STN): Pixels are randomly selected as seed pixels around which spatially and temporally auto-correlated noise is added. First, strength of temporal auto-correlation is randomly selected. This determines how many time steps around the time step of the seed pixel would be affected by noise. Then for each of those time step, spatially auto-correlated noise is added around seed location using the strategy described before.

### 3.1.2 Evaluation Measure

The goal of classification enhancement is to correct the noisy labels (i.e. misclassified instances) without incorrectly flipping the labels of the correctly classified instances in the input. The performance of different classification enhancement techniques are compared using the following performance measure:
n_{A}=number of misclassified instances after algorithm A
n₀=number of misclassified instances in input

$$Performance ( algorithm A ) = 1 - \frac{{n}_{A}}{{n}_{o}}$$

### 3.1.3 Results

### Role of Simultaneous Estimation

Direct inference of the physical properties from imperfect classification may lead to incorrect estimates. SELPh improves the technology of computer-based water extent determination by simultaneously optimizing the two tasks of (i) inferring the physical properties and (ii) enhancing the classification. In Table 1 below, the performance of the direct inference based approach (SEQ) is compared with SELPh for all three label noise types in Table 1 (40% noise was added to the input labels). The results clearly indicate that simultaneous estimation considerably improves the classification enhancement performance.

TABLE 1
Comparison of SELPh with single step SEQ approach
for 40% noise added to input labels.

| | RN | SN | STN |
|---|---|---|---|
| SEQ | 73 | 70 | 68 |
| SELPh | 90 | 85 | 80 |

Comparison with Traditional Spatial and Temporal Filtering Schemes

Spatial and temporal smoothing approaches are widely used in remote sensing image analysis for classification enhancement. Simple spatial majority (SS) and temporal majority (TS) filters can both be used for classification enhancement. The width of the filters was varied and the results below are for the width parameter that gave the best results. Our results in Tables 2, 3 and 4 demonstrate that SELPh shows a better performance compared to majority filters in presence of high levels of noise in classification, especially in context of spatially and temporally auto-correlated noise. In fact, Tables 3 and 4 show that spatial filtering scheme SS, which is one of the most commonly used approach in de-noising of remote sensing images, shows an extremely poor and erratic performance when encountered with spatial and spatio-temporally auto-correlated noise. This is because it is unable to correct incorrect classifications as they occur as big spatial patches and may also incorrectly smooth sharp boundaries of lakes. Temporal filtering TS shows relatively better performance, especially when noise is only spatial in nature and temporally random. Finally, the SELPh approach, which does not assume either temporal or spatial randomness in the noise process, shows the best performance on maps plagued with spatial and spatio-temporal noise.

TABLE 2
Performance of different classification enhancement
strategies for random noise process

| | SS | TS | SELPh |
|---|---|---|---|
| 10% | 77 | 64 | 93 |
| 20% | 85 | 50 | 90 |
| 40% | 57 | 15 | 89 |

TABLE 3
Performance of different classification enhancement
strategies for spatial noise process.

| | SS | TS | SELPh |
|---|---|---|---|
| 10% | 7 | 70 | 90 |
| 20% | 8 | 55 | 88 |
| 40% | 3 | 25 | 84 |

TABLE 4
Performance of different classification enhancement
strategies for spatio-temporal noise

| | SS | TS | SELPh |
|---|---|---|---|
| 10% | 7 | 40 | 91 |
| 20% | 9 | 30 | 87 |
| 40% | 6 | 12 | 80 |

process SELPh performance improves with increase in number of images

The efficacy of SELPh lies in the ability to reconstruct the elevation ordering despite presence of noise in the initial classification product. It is obvious that the accuracy of the estimated elevation order depends on the level of noise in the input classification. However, for the same level of noise in the input classification, the performance of SELPh significantly improves as the number of time steps (images) is increased (see Table 5). This is due to the fact that during the estimation of the depth order, the embodiments leverage the additional information present in a larger set of images because elevation remains fixed across all time steps. Traditional spatial and temporal methods that only consider local (spatially and temporally) context for classification enhancement fail to exploit information in additional images, and their performance is relatively independent of the number of images available.

TABLE 5
Impact as the number of time steps is increased from
50 to 500 on different classification enhancement strategies
(for 40% spatio-temporal noise process).

| | 50 | 100 | 200 | 500 |
|---|---|---|---|---|
| SELPh | 37 | 60 | 78 | 90 |
| SS | 9 | 9 | 8 | 9 |
| TS | 20 | 21 | 20 | 20 |

### Sensitivity to Number of Buckets

The ordered graph approach of the SELPh algorithm requires a user-specified parameter—the number of buckets (i.e. the number of depth contours) to be created for a lake. In principle, each contour corresponds to a unique water level for the lake. Since there only a finite number of satellite images and each image can only provide at most one unique water level, the number of buckets is upper bounded by the number of time steps. Therefore, in one embodiment, the number of buckets is set as the number of time steps for which the classified images are available. However, in practice, due to temporal and seasonal auto-correlations, the number of unique water levels are typically lower than the total number of time steps. This is reflected in Table 6 that shows the variation in the performance of SELPh with the choice of number of buckets. SELPh performance first increases rapidly with increase in the number of buckets used (till a point where the number of buckets reach the underlying number of unique water levels for the lake) and then it remains constant with any further increase in the number of buckets.

TABLE 6
Impact of increasing the number of buckets from 50 to 500 (for
40% spatio-temporal noise process using 500time steps).

| | 50 | 100 | 150 | 200 | 250 | 300 | 500 |
|---|---|---|---|---|---|---|---|
| SELPh | 44 | 68 | 81 | 87 | 89 | 90 | 90 |

### 3.2 Case Study: Lake Mead, Calif.

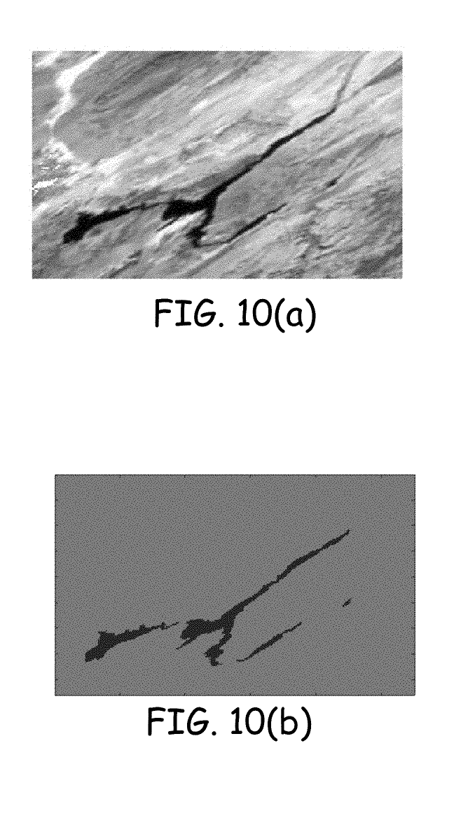

The synthetic data set used in the previous section is generated by modeling of both the (i) lake physics and (ii) noise processes. In this case study, we evaluate on a semi-synthetic data set that is generated from real data (which retains lake physics) but synthetically introducing classification noise. Lake Mead has a significant dynamics in the last decade due to ongoing droughts in California. Moreover, the original classification maps for this lake are of high quality and therefore can be considered as ground truth. To compare different algorithms we added noise to the original classification. FIG. 10(a) shows false color composite image of Lake Mead in September, 2007 and FIG. 10(b) shows the corresponding SELPh output, where water is shown as black in both FIGS. and land and clouds are depicted by lighter colors. For this lake, the performance of SELPh approach is 76%. This is significantly higher compared to temporal filtering (18%). In fact, spatial filtering completely failed to enhance the classification maps for this lake. Spatial filtering tends to make mistakes on pixels lying at the boundary of the two classes. Since Lake Mead has a linear shape (long boundary), this issue gets exacerbated.

### 3.3 Case Study: Lake Abbe, Ethiopia

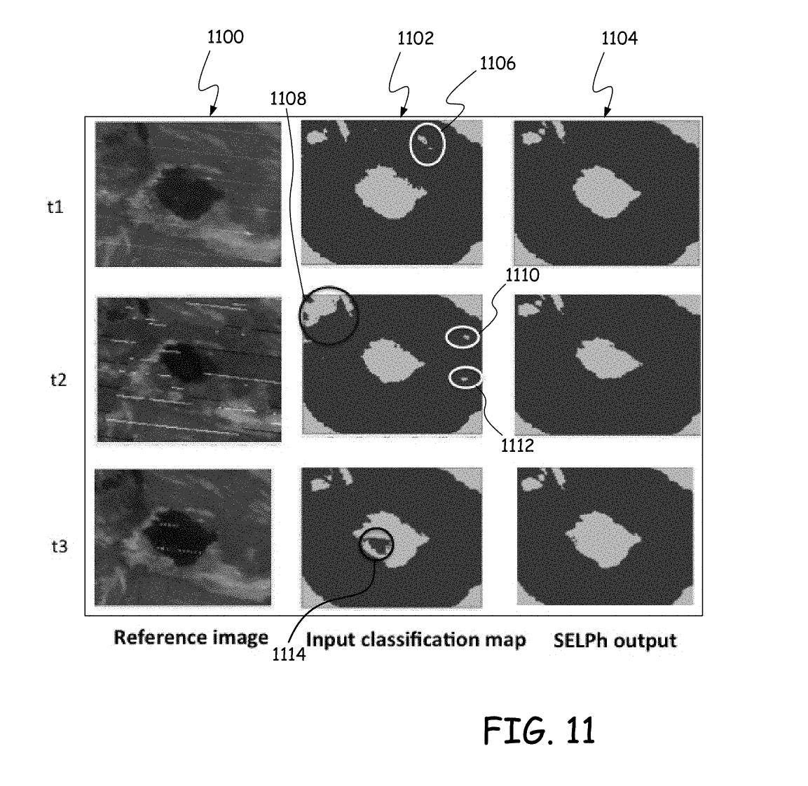

FIG. 11 shows images of Lake Abbe in column 1100, the initial classification maps of Lake Abbe in column 1102 and the revised classifications for Lake Abbe obtained from an embodiment of SELPh in column 1104 for three different time steps t1, t2 and t3. Each pixel is classified into either water (light colors) or land (dark colors). The key differences between the initial classification and SELPh ouput are highlighted in circles 1106, 1108, 1110, 1112 and 1114. Comparing the imagery in the spectral composites of column 1100 to the classifications in columns 1102 and 1104 shows that the initial classification 1102 suffered from some misclassifications, and that the label re-assignments done by SELPh are indeed correct (in agreement with the water body outline visible in the spectral composites).

It is also important to observe that the errors in initial classification are spatially auto-correlated. For example, the errors inside the circle 1108 and circle 1114 clearly show entire patches being misclassified. Furthermore, these errors were also temporally auto-correlated, i.e. persisted for multiple consecutive time steps. Later in the synthetic data experiments we show that traditional filtering schemes have a poor performance when dealing with such spatially and temporally auto-correlated noise.

Finally, note that the surface of this lake water body is quite dynamic and all three time steps differ in their surface area. The lake was medium-sized in the early years (time step t1), shrank considerably in the middle years (time step t2), and finally grew in size during the last few years (time step t3). If SELPh is not applied on the initial classified images, due to the misclassifications in these images the exact behavior of the lake surface can be misunderstood. For example, there is a large patch that is misclassified as land in the middle of the lake at time t3. If we estimate the lake surface area for time step t3 from the classified image, we will get an incorrect estimate due to this misclassified patch.

### 4 Comparison of Ordered Graph Partitioning and Profile Match Approaches

The ability of the SELPh approach to iteratively improve the estimates of the physical properties and final classification rests on certain assumptions on the nature of the imperfections present in the input classification. If these assumptions are violated, then the performance of that method can get impacted. For example, both the ordered graph partitioning and profile matching embodiments assume that the probability of error in the input classification is less than 0.5, i.e. P(pᵢ^{t}=W|yᵢ^{t}=L)<0.5 and P(pᵢ^{t}=L|yᵢ^{t}=W)<0.5. The profile matching additionally assumes that there is no missing data and that the probability of error in the two classes is identical, i.e. P(pᵢ^{t}=W|yᵢ^{t}=L)=P(pᵢ^{t}=L|yᵢ^{t}=W). However, in practice the classification maps typically show class conditional noise, i.e. probability of error in one of the classes is greater than the other. In the experiments described above, it was observed that these two elevation-ordering based approaches showed similar performance on data sets where P(pᵢ^{t}=W|yᵢ^{t}=L)=P(Pᵢ^{t}=L|yᵢ^{t}=W), but the embodiments have a considerably better performance in presence of class conditional noise compared to the profile matching method as seen in Table 7.

TABLE 7
Comparison of SELPh with PM approach
for class conditional noise.

| | RN | SN | STN |
|---|---|---|---|
| PM | 72 | 70 | 65 |
| SELPh | 84 | 83 | 78 |

### 5 Limitations of the Approach

In this section we discuss some of the limitations of our approach for correcting misclassifications of the original input classification maps.

The method requires certain degree of randomness in the noise process in order to infer depth and perform classification enhancement. It is less effective in cases where there is systematic class confusion, i.e. certain patches of land are regularly misclassified due to bias in the classifier. For example, if a certain type of vegetation is misclassified as water at all time steps, then SELPh approach will fail to correct such errors.

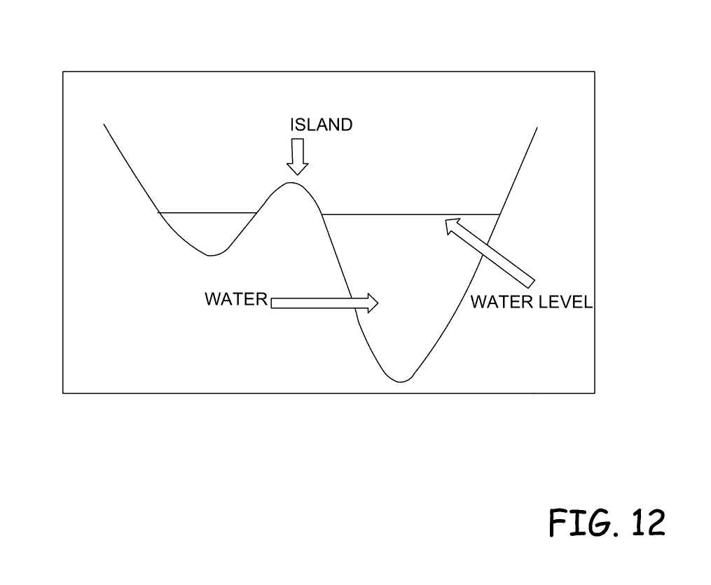

The SELPh approach requires that all pixels of the lake up to a certain height are water, and all others are land. For example, the lake shown in FIG. 12 consists of two concave surfaces. If the water fills to same height in the two concave bowls at all time steps, then SELPh approach is able to correct the misclassifications. However, if it happens that the water height is different for the two bowls, then SELPh performance degrades. To address this, we need to first preprocess the data to separate different lake bodies and then apply SELPh on each lake independently.

If the class label for a pixel is unobserved throughout the entire time period, then there is no information to estimate the elevation of this pixel and the presented SELPh method does not assign any label to such pixels. Since the elevation field exhibits a certain degree of spatial smoothness, future extensions can potentially leverage elevation estimates of nearby pixels in order to estimate elevation for such pixels. However, in practice such a situation occurs rarely.

Finally, our embodiments assume that the elevation of a location remains fixed across all time steps. In some cases, e.g. erosion or volcanic and earthquake activity, it is possible that the elevation of pixels change over time thereby changing the lake geometry. In such cases one should apply SELPh on shorter temporal windows in which the probability of elevation changes is much smaller.

### 6 Concluding Remarks

The present embodiments provide SELPh, a new physics-guided classification enhancement technique to improve computer-based automatic lake extent monitoring by leveraging the constraints enforced by the law of gravity. SELPh is able to correct errors much more effectively than other techniques such as temporal and spatial filtering that do not take into account physical properties. In addition to reducing misclassifications, SELPh also correctly imputes missing labels.

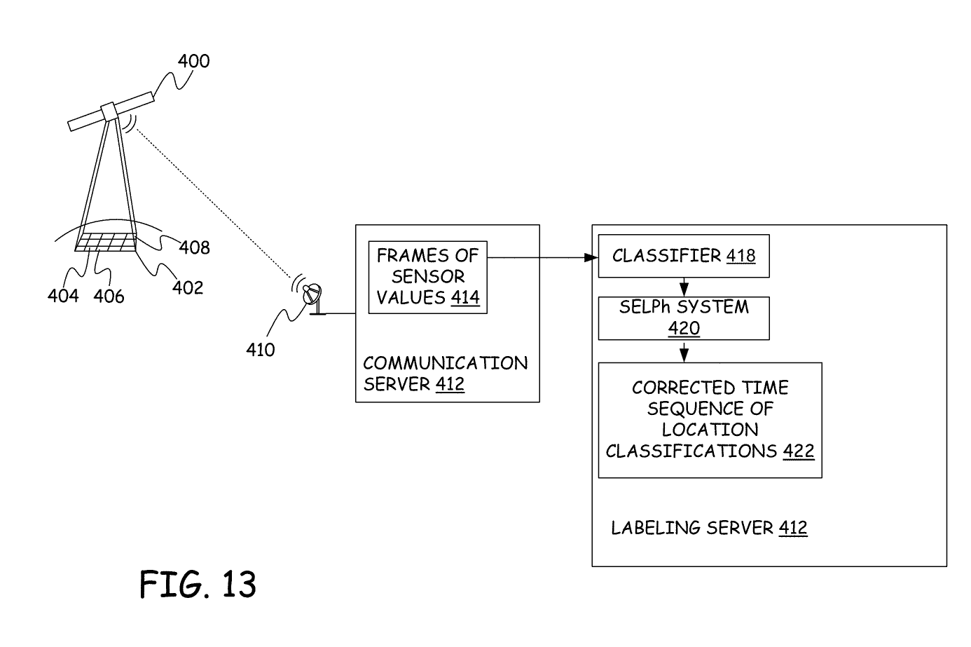

FIG. 13 provides a system diagram of a system used to improve the efficiency and accuracy of computer-based labeling technology that automatically labels satellite data to determine the extent of bodies of water. In FIG. 13, a satellite 400, positioned in orbit above the earth and having one or more sensors, senses values for a geographic location 402 that is comprised of a plurality of geographic areas/smaller geographic locations 404, 406 and 408. Multiple sensors may be present in satellite 400 such that multiple sensor values are generated for each geographic area of geographic location 402. In addition, satellite 400 collects frames of sensor values for geographic location 402 with each frame being associated with a different point in time. Thus, at each point in time, one or more sensor values are determined for each geographic area/smaller geographic location in geographic location 402 creating a time series of sensor values for each geographic area/smaller geographic location. Satellite 400 transmits the sensor values to a receiving dish 410 which provides the sensor values to a communication server 412. Communication server 412 stores the sensor values as frames of sensor values 414 in a memory in communication server 412. A labeling server 416 receives frames of sensor values 414 and provides the received frames of sensor values to a classifier 418, which classifies each geographic area/smaller geographic location in each frame into one of a set of classes such as Land or Water. Classifier 418 provides the classifications for the geographic areas/smaller geographic locations to a SELPh system 420 of the present embodiments. SELPh system 420 then performs iterations during which it alternates between identifying a water level for each frame based on a current hierarchical order of the geographic areas/smaller geographic locations and the land cover classes assigned to the geographic areas/geographic classes for the frame and reordering the geographic areas/smaller geographic locations based on the new water levels so as to minimize the mismatch between the classes expected of the geographic area/smaller geographic location given the water level and classes actually assigned to the geographic area/smaller geographic location. When the iterations are complete, the land cover classes predicted by the final order for the geographic areas/smaller geographic locations and the final time sequence of water levels are output as the time-sequences of land cover classes for the geographic areas/smaller geographic locations 422. The output time-sequences of land cover classes 422 corrects erroneous classifications in the original classifications of the geographic areas/smaller geographic locations provided by classifier 418.

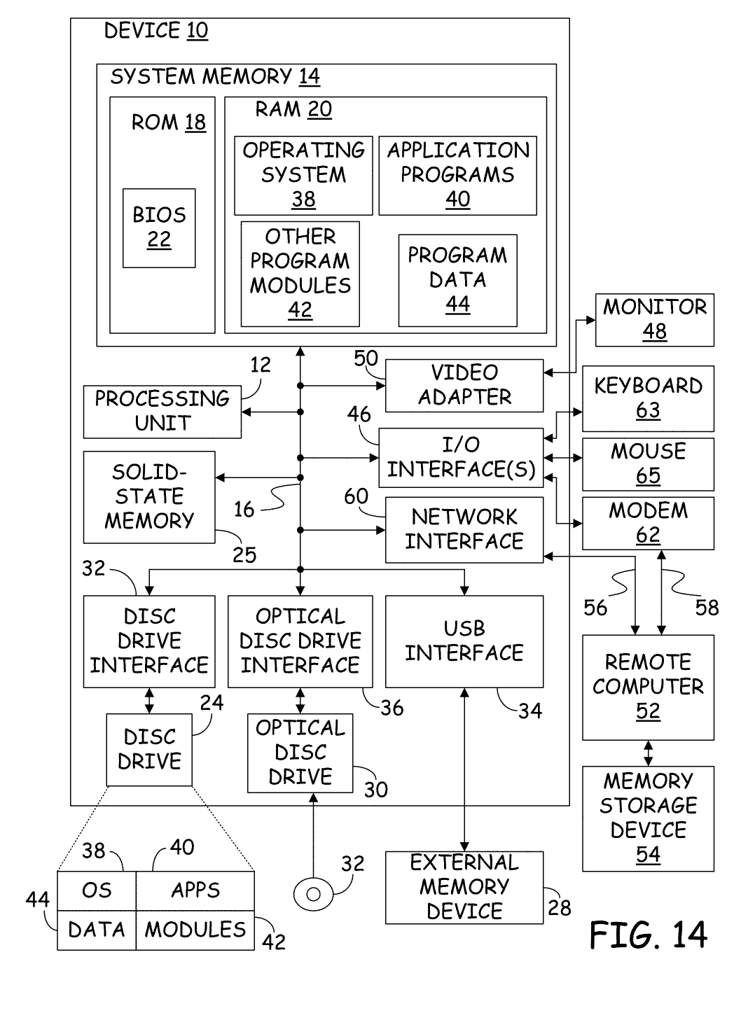

An example of a computing device 10 that can be used as a server and/or client device in the various embodiments is shown in the block diagram of FIG. 14. For example, computing device 10 may be used to perform any of the steps described above. Computing device 10 of FIG. 14 includes a processing unit (processor) 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid state memory and external memory devices and their associated computer-readable media provide nonvolatile storage media for computing device 10 on which computer-executable instructions and computer-readable data structures may be stored. Other types of media that are readable by a computer may also be used in the exemplary operation environment.

A number of program modules may be stored in the drives, solid state memory 25 and RAM 20, including an operating system 38, one or more application programs 40, other program modules 42 and program data 44. For example, application programs 40 can include instructions for performing any of the steps described above. Program data can include any data used in the steps described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

Computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 14. The network connections depicted in FIG. 14 include a local area network (LAN) 56 and a wide area network (WAN) 58. Such network environments are commonplace in the art.

Computing device 10 is connected to the LAN 56 through a network interface 60. Computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 15 are exemplary and other means for establishing a communications link between the computers, such as a wireless interface communications link, may be used.

Although elements have been shown or described as separate embodiments above, portions of each embodiment may be combined with all or part of other embodiments described above.

Although the present invention has been described with reference to preferred embodiments, workers skilled in the art will recognize that changes may be made in form and detail without departing from the spirit and scope of the invention.

What is claimed is:

1. A method of improving automated water body extent determinations using satellite sensor values, the method comprising:
a processor receiving a time-sequence of land cover labels for a plurality of geographic areas represented by pixels in the satellite sensor values;
the processor alternating between ordering the geographic areas based on a water level estimates at each time point in the time sequence such that the order of the geographic areas reflects an estimate of the relative elevations of the geographic areas and updating the water level estimates based on the land cover labels for the geographic areas; and
using a final ordering of the geographic areas and a final water level estimate to correct the time-sequence of land cover labels.

2. The method of claim 1 wherein ordering geographic areas based on a water level comprises dividing pixels into buckets of pixels.

3. The method of claim 2 wherein dividing pixels into buckets of pixels comprises dividing a bucket of pixels so as to form two buckets in which the pixels in the two buckets are more homogenous than in the bucket being divided.

4. The method of claim 3 wherein dividing a bucket of pixels comprises building a directed graph for pixels at each time point.

5. The method of claim 3 wherein ordering geographic areas based on water level estimates further comprises setting land cover labels for pixels based on the water level estimates.

6. The method of claim 1 wherein updating the water level estimate comprises identifying a water level at each time point that would alter a minimum number of land cover labels for the ordered geographic areas.

7. The method of claim 1 wherein ordering the geographic areas based on the water level estimates comprises determining a sequence of land cover labels for each of a set of elevations based on the water level estimate and assigning a geographic area to an elevation where the sequence of land cover labels for the elevation best matches the sequence of land cover labels for the geographic area.

8. A system comprising:
a memory storing a time sequence of land cover labels for a plurality of geographic locations wherein the time sequences of land cover labels are generated from satellite sensor data; and
a processor performing steps comprising:
iteratively establishing a relative elevation for each geographic location in the plurality of geographic locations and a water level at each time point in the time sequence to form final relative elevations for the plurality of geographic locations and final water levels at each time point; and
using the final relative elevations for the plurality of geographic locations and the final water levels to modify the time sequence of land cover labels for the plurality of geographic locations to thereby correct at least one land cover label.

9. The system of claim 8 wherein iteratively establishing a relative elevation for each geographic location comprises iteratively dividing geographic locations into groups of geographic locations.

10. The system of claim 9 wherein iteratively dividing the geographic locations into groups of geographic locations comprises constructing a directed graph at each time point and dividing the geographic locations based on a number of edges in the directed graph that would be established between different groups of geographic locations.

11. The system of claim 10 wherein establishing a water level at each time point comprises minimizing a number of changes in the land cover labels at each time point caused by the water level.

12. The system of claim 8 wherein establishing a relative elevation of each geographic location comprises using the water level to set a sequence of land cover labels for each of a set of elevations, comparing the sequence of land cover labels for a geographic location to the sequence of land cover labels for each elevation, and setting the geographic location at an elevation that has a sequence of land cover labels that is most similar to the sequence of land cover labels of the geographic location.

13. The system of claim 12 wherein using the water level to set a sequence of land cover labels comprises for each time point setting all elevations below the water level to a land cover label of water and all elevations above the water level to a land cover label of land.

14. The system of claim 12 wherein the set of elevations comprises as many elevations as geographic locations in the plurality of geographic locations.

15. A computer-implemented method comprising:
setting a time-sequence of water levels relative to a set of geographic locations based on land cover labels for the geographic locations;
organizing the geographic locations based on the time-sequence of water levels to form an ordered list of geographic locations; and
using the ordered list of geographic locations and the time-sequence of water levels to correct an error in at least one of the land cover labels.

16. The computer-implemented method of claim 15 wherein the ordered list of geographic locations comprises an ordered list of buckets of geographic locations.

17. The computer-implemented method of claim 15 wherein organizing the geographic locations comprises dividing an existing bucket of geographic locations into two buckets of geographic locations based on the time-sequence of water levels.

18. The computer-implemented method of claim 17 wherein dividing an existing bucket of geographic location into two buckets of geographic locations comprises selecting a bucket to divide that has the largest number of dissimilar land cover labels for different geographic locations in the bucket.

19. The computer-implemented method of claim 15 wherein setting a time-sequence of water levels based on land cover labels for geographic locations comprises setting the time-sequence of water levels based on an order for the geographic locations and the land cover labels for the geographic locations.

20. The computer-implemented method of claim 19 wherein the order for the geographic locations is based on a previously determined time sequence of water levels.
